(19) United States
(12) Patent Application Publication
(10) Pub. No.: US 2002/0030122 A1
(43) Pub. Date: Mar. 14, 2002

(54) Method and apparatus for generating water sprays, and methods of cleaning using water sprays

(75) Inventors: Howard Anthony Barnes, Bebington (GB); Clare Butler-Ellis, Silsoe (GB); Paul Miller, Silsoe (GB); Matthew James Leach, Casalpusterlengo (IT); Dikshika Patel, Bebington (GB)

Correspondence Address: UNILEVER, PATENT DEPARTMENT, 45 RIVER ROAD, EDGEWATER, NJ, 07020, US

(73) Assignee: Diversey Lever, Inc.

(21) Appl. No.: 09/824,354

(22) Filed: Apr. 2, 2001

(30) Foreign Application Priority Data
Apr. 4, 2000 (EP) 00302851.1
Oct. 13, 2000 (EP) 00309011.5

(51) Int. Cl. B05B 7/06

(52) U.S. Cl. 239/423

(57) ABSTRACT

A water spray has a nozzle (6) for carrying a pressurised flow of water to an outlet (7) thereof, and a conduit (12) surrounding the nozzle outlet (7) for carrying a flow of gas contiguously around the flow of cleaning liquid exiting said nozzle outlet (7). The ratio of velocities of gas and water immediately downstream of the nozzle is in the range 0.5 to 2. This enables good control of water droplet size in the spray, to a volume median diameter in the range 0.5 to 2 mm at 1 m from the nozzle. Low water pressures may be employed in cleaning using such a spray.

### FIELD OF THE INVENTION

This invention relates to a method of generating a water spray, to a method of cleaning a hard surface using such a spray and to water spray apparatus for use particularly in cleaning of hard surfaces.

### DESCRIPTION OF THE PRIOR ART

Water sprays are used for the cleaning of hard surfaces, such as the exterior surface of vehicles and in the cleaning of interior walls, ceilings and floors of buildings, for example in food manufacturing and processing plants where soil of biological material becomes adhered to the walls. Pressurised water is ejected from a nozzle as a spray, for example a spray of fan shape, and directed at the surface to be cleaned. The water droplets of the spray achieve their effect by erosion of the soil on the surface being cleaned. The kinetic energy or momentum of the water droplets dislodges the soil particles.

Air drag on the droplets of the spray reduce their velocity significantly over distances such as 1 or 2 meters, reducing the cleaning effect. To counteract this, it has been practised to increase the pressure of the water supplied to the nozzle, to increase the velocity of the emerging water. While this generates a high velocity, it involves extra cost and environmental problems, and results in formation of droplets of smaller size, which the present inventors believe have a lesser cleaning power on typical surface soils.

In the context of the present invention, it is mentioned that it is also known to use air to atomize the liquid emerging from spray nozzles. One form of such nozzle is an internal air assist nozzle where air is introduced into the liquid stream within a mixing chamber within the body of the nozzle. Another example is an external air assist nozzle where high velocity air impinges on the liquid as it emerges from the nozzle aperture, so as to atomize the liquid. The aim with such an air assist nozzle is to produce generally a spray of low velocity and fine droplets, e.g. less than 50 μm diameter, e.g. for the formation of fogs or mists. Examples of such processes, not limited to the spraying of water, are in fuel combustion, cooling and chemical processing. Air assist spray nozzles can offer a wide range of spray patterns, flow rates and degree of atomisation.

EP-A-294690 describes an atomiser for cleaning liquid, particularly water, for use in the electronics and computer industries to obtain ultra clean surfaces. The aim is to achieve a high degree of atomisation of the water. The cleaning liquid is injected into a tube, which is carrying a flow of pressurised gas. The velocity of the gas is high, approaching sonic velocity within the tube. This atomises the liquid flow and accelerates the liquid droplets to a high velocity, which is said to be at least equal to half that of the air. The ratio of liquid to gas flow rate is less than 1/1000, and low liquid flow rates of less than 30 ml/minute are envisaged. At the impact with the surface being cleaned, air velocity in excess of 300 m/s and liquid droplet velocity in excess of 150 m/s are mentioned. Such a nozzle is not useful for the cleaning of large areas, such as building surfaces, because of the high air velocity and low liquid volume.

### SUMMARY OF THE INVENTION

The object of the invention is to provide a method of generating sprays, particularly for cleaning of hard surfaces, and apparatus for use in the method, by which improved cleaning performance is obtained.

The present inventors, noting that all sprays break into droplets soon after emergence from the nozzle into the external air, believe that adequate attention has not been paid to the generation of water droplets in a water spray, especially in the context of cleaning of surfaces.

According to the invention in one aspect there is provided a method of generating a water spray comprising ejecting water under pressure from a nozzle opening to form a water stream and providing a gas flow alongside the ejected water stream travelling in generally the same direction the relative velocities of the water stream and the gas flow being such that, at a distance of 1 m from the nozzle opening the volume median diameter of the water droplets is in the range of 0.5 to 2 mm.

Preferably the ratio of the velocity of the gas flow to the velocity of the water stream immediately downstream of the nozzle opening is in the range 0.5 to 2.

In contrast with the prior art methods described above, the present inventors believe that for improvement of cleaning effect, in particular soil removal from hard surfaces, the size of the particles produced should be carefully controlled, and in particular should be controlled to within the relatively large size range 0.5 to 2 mm. In the invention in this aspect, the gas flow which is provided around the emerging water stream, which for cleaning purposes will typically be an air flow, is selected to have a velocity rate, relative to the water stream, such that water droplets of the desired dimensions are produced, and has a second effect of maintaining the velocity of the water droplets towards the target surface. Consequently, the relatively large droplets arriving at the cleaning surface have a high cleaning power, due to their considerable momentum. The use of high water pressure in the nozzle, which had previously been thought necessary to enhance cleaning power, can be avoided. The provision of the air flow not only entrains the water droplets towards the surface being cleaned, but also, as mentioned, controls the formation of the droplets, and reduces the tendency of the surrounding air to atomise the droplets, as is the case when a high pressure water stream emerges from a nozzle into still air.

According to the invention in another aspect there is provided a method of generating a water spray comprising ejecting water under pressure from a nozzle opening to form a water stream and providing a gas flow alongside the ejected water stream travelling in generally the same direction, the ratio of the velocity of the air flow to the velocity of the water stream immediately downstream of the nozzle opening being in the range 0.5 to 2.

Preferably the ratio of the velocities of the gas flow and the water stream immediately downstream with the nozzle opening are in the range 0.75 to 1.5, more preferably 0.8 to 1.2.

The volumetric ratio of the gas flow to the water stream (expressed as volume/s) is preferably at least 100, and more preferably at least 200. In principle there is no upper limit on this ratio, since a larger gas flow volume at an appropriate velocity does not have a disadvantageous effect, except on the cost of producing the gas flow. Preferably the value of this ratio is not more than 600 since a larger gas volume is unlikely to provide any benefit. In this specification, gas volumes are expressed at normal temperature and pressure.

Water droplet size is measured as VMD, which is volume median diameter. The volume median diameter at 1 m from the nozzle opening is preferably in the range 0.5 to 1.5 mm, and is more preferably greater than 1 mm, e.g. at least 1.02 mm. The average water droplet velocity at 1 m from the nozzle opening is preferably not more than 35 m/s, more preferably not more than 30 m/s. The minimum velocity at 1 m from the opening is preferably 15 m/s, more preferably 20 m/s.

Within the invention, high total water flow rates are envisaged. Preferably the water flow rate is in the range 14 to 28 l/min. Because the spray produced has relatively large droplets, a high water flux (flow rate per unit cross sectional area) can be obtained.

The gas used for the gas flow in the invention will normally be air, in view of cost and convenience, but it is possible to envisage applications of the invention when another gas is employed, e.g. a gas not containing oxygen such as nitrogen gas, for example if the spray is used for fire extinguishing.

According to the invention in another aspect there is provided apparatus for generating a water spray, adapted and arranged for use in the method of the invention as described above.

In accordance with the invention in another aspect there is provided apparatus for generating a water spray, having a water spray nozzle with an opening for the ejection of a water stream, means for providing a flow of pressurised water to the nozzle opening, an gas flow tube surrounding the nozzle opening and extending downstream thereof to an open end, and means for providing a gas flow along the gas flow tube alongside the water stream ejected from the nozzle opening, wherein the ratio of the cross sectional areas of said opening of the nozzle and of the gas flow tube at the location of the nozzle is in the range 1/50 to 1/600, preferably 1/100 to 1/400. The nozzle is preferably capable of providing a flow rate of water of at least 14 l/min. The minimum internal cross sectional dimension of the gas flow tube at the nozzle opening and downstream thereof is preferably at least 30 mm, preferably at least 40 mm. This dimension is the internal diameter of the tube in the case of a circular tube, but non-circular tubes may be employed, for example elliptical tubes. The internal dimension of the gas tube at the location of the nozzle opening is preferably not more than 100 mm. The length of the gas flow tube downstream of the nozzle opening is preferably in the range 1 to 3 times the average cross-sectional dimension of the gas flow tube at the location of the nozzle opening, more preferably in the range of 1 to 2 times this average cross-sectional dimension. In the case of a circular gas flow tube, this average cross-sectional dimension is the diameter. Downstream of the water nozzle opening, the gas flow tube may be converging or diverging, but preferably has a substantially constant cross-sectional area. It is desirable that the emerging water spray does not contact the gas tube, but desirably the tube is as long as possible.

The nozzle opening typically has a slit shape. It is preferred in the invention that the spray produced has a fan shape, i.e. has a long dimension and a short dimension perpendicular to the long dimension, and expands at least in the long dimension with increasing distance from the nozzle opening.

Since the water spray generally expands after emerging from the nozzle opening, the gas flow direction in the air tube is generally in the same direction as the water spray, e.g. parallel to an axis of the emerging water stream. The gas flow is preferably at least at opposite sides of the water spray and preferably substantially surrounds the water spray, as a gas shroud.

The invention is applicable to water sprays. The water preferably does not contain any solid particulate matter, but may contain quantities of solute material, e.g. less than 5% by weight.

In another aspect the invention provides a method of cleaning a hard surface comprising directing at the surface a water spray generated by the method of the invention. Preferably the hard surface is at a distance in the range 1 to 4 m from the nozzle opening. The invention is especially applicable to the cleaning of soil, such as food soil, from hard surfaces, such as wall, ceiling and floor surfaces of a building.

Because the method of the invention can achieve better cleaning effects, the advantage of reduced water use can be achieved. Also good cleaning of large areas remote from the nozzle can be achieved quickly.

### INTRODUCTION OF THE DRAWINGS

A preferred embodiment of the apparatus of the present invention will now be described in further detail with reference to the accompanying drawing, in which:

FIG. 1 is a cross-sectional view of the apparatus according to the preferred embodiment;

FIG. 2 shows an end view (a) and side view (b) of the preferred liquid nozzle incorporated in the apparatus of FIG. 1; and

FIG. 3 is a schematic cross-sectional view of the preferred apparatus of FIG. 1, along arrow “A”.

### PREFERRED EMBODIMENTS AND EXAMPLES

A preferred apparatus according to the invention as shown schematically in the drawing comprises a pneumatic air mover 4 comprising air inlet 20 and delivery conduit 12 of circular cross-section which surrounds the outlet end 7 of the cleaning water nozzle 6, which is in communication with the main water delivery pipe 8, into which cleaning water is supplied through inlet 10 through a suitable conventional pressure inlet source (not shown). In the preferred embodiment the air mover 4 is a Model RJ50A Ringjet Airmover from O. N. Beck & Co Ltd, which is able to produce an air jet with a peak exit velocity at the mouth 14 of about 25 ms⁻¹. The water nozzle opening is slit-shaped. The nozzle 6, which is also of conventional design, was fitted to the commercially available air mover 4 by the inventors.

In this embodiment the delivery conduit 12 of the air mover 4 has an internal diameter of 67 mm, the distance between the nozzle outlet end 7 and the mouth 14 of the delivery conduit 12 being approximately 120 mm. The air supply is provided by compressed air at a pressure of up to 4.0 bar, although variation in the outlet air velocity is possible by a adjustment of the air mover setting.

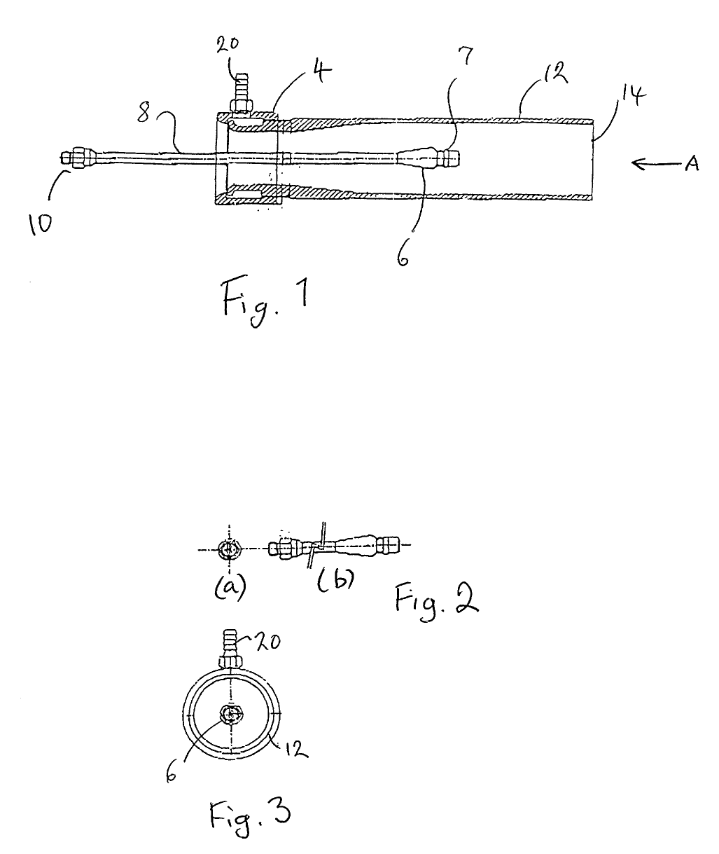

Using the spray device of FIGS. 1 to 3, air velocities, in the absence of water spray, were determined in dependence on the pressure of air supplied to the air mover 4.

Velocity was measured at 100 mm from the exit 14 by a vane anemometer. The result is shown in Table 1.

Table 1. Mean air velocities 100 mm from air mover exit.

| Air pressure, bar | Velocity, ms⁻¹ |
|---|---|
| 1.0 | 11.0 |
| 1.5 | 12.5 |
| 2.0 | 15.0 |
| 2.5 | 17.0 |
| 3.0 | 19.0 |
| 3.5 | 20.5 |
| 4.0 | 22.5 |

Cleaning performance at two different water pressure and various air pressures was assessed by a standardised internal test of Unilever, in which an artificial protein soil, which is coated on stainless steel tiles and is very hard to remove, is partially removed by the spray.

The distances from the spray nozzle to the surface were 1 m for tests designated with suffix A and 2 m for tests designated with suffix B.

Water pressures, air pressure and % by weight removal of soil are given in Table 2.

It was noted that the spray angle (angular width of the spray) was narrowed or more focussed as a result of the air flow around the nozzle. This appears to cause the spray pattern to oscillate, so that it appears to have a wave or S-shape.

TABLE 2
Soil removal results

| | Distance | | | |
|---|---|---|---|---|
| | from | Water | Air | |
| | nozzle | pressure | pressure | Removal |
| Test No. | (m) | (bar) | (bar) | (wt %) |
| 1B | 2 | 20 | 0 | 31.29 |
| 2A | 1 | 4.8 | 0 | 14.21 |
| 2B | 2 | 4.8 | 0 | 19.47 |
| 3B | 2 | 4.8 | 1 | 16.07 |
| 4B | 2 | 4.8 | 2 | 31.40 |
| 5A | 1 | 4.8 | 3 | 12.17 |
| 5B | 2 | 4.8 | 3 | 22.89 |
| 6A | 1 | 4.8 | 4 | 20.80 |
| 6B | 2 | 4.8 | 4 | 24.37 |

These results show that with low water pressure (4.8 bar) and a surrounding air flow, good cleaning rates can be achieved and can be equivalent to that achieved with high pressure water (20 bar) without surrounding air flow. Where lower removal is achieved in this standard test, the water flow rate is much lower also, i.e. use of water is at least as efficient, and only low water pressure is required, with possible cost benefit.

Measurements were then made to obtain the mean values of air velocity and water velocity, using a Phase Doppler analyser. Measurements of velocity were taken at the centre of the spray, as the average in a cross-sectional area 7.5×7.5 cm, at 1 m and 2 m from the nozzle. Also measured at the same locations was volume median diameter (VMD) of the droplets. The results are given in Table 3. Air pressure of zero means no air was flowing.

TABLE 3

| Test no. | 1B | 2A | 2B | 4B | 5B | 6A | 6B |
|---|---|---|---|---|---|---|---|
| Distance of | 2 | 1 | 2 | 2 | 2 | 1 | 2 |
| measurements | | | | | | | |
| from nozzle | | | | | | | |
| (m) | | | | | | | |
| Water | 20 | 4.8 | 4.8 | 4.8 | 4.8 | 4.8 | 4.8 |
| pressure | | | | | | | |
| (bar) | | | | | | | |
| Air pressure | 0 | 0 | 0 | 2 | 3 | 4 | 4 |
| (bar) | | | | | | | |
| Water | 25.7 | 22.7 | 17.9 | 19.8 | 21.1 | 26.9 | 20.9 |
| velocity | | | | | | | |
| (m/s) | | | | | | | |
| Air velocity | 19.8 | 11.9 | 9.6 | 9.8 | 9.9 | 15.2 | 10.8 |
| (m/s) | | | | | | | |
| VMD | 337 | 950 | 1035 | 1041 | 1223 | 1303 | 1099 |
| (μm) | | | | | | | |

These results, when correlated with cleaning performance in Table 2, shows that the presence of large droplets, at about 1 mm VMD, with velocity in the region 20 m/s gives good cleaning performance at 2 m from the spray nozzle.

1. A method of generating a water spray comprising ejecting water under pressure from a nozzle opening to form a water stream and providing a gas flow alongside the ejected water stream travelling in generally the same direction, the relative velocities of the water stream and the gas flow being such that, at a distance of 1 m from the nozzle opening the volume median diameter of the water droplets is in the range of 0.5 to 2 mm.

2. A method according to claim 1 wherein the ratio of the velocity of the gas flow to the velocity of the water stream immediately downstream of the nozzle opening is in the range 0.5 to 2.

3. A method of generating a water spray comprising ejecting water under pressure from a nozzle opening to form a water stream and providing a gas flow alongside the ejected water stream travelling in generally the same direction, the ratio of the velocity of the gas flow to the velocity of the water stream immediately downstream of the nozzle opening being in the range 0.5 to 2.

4. A method according to claim 3 wherein said velocity ratio is in the range of 0.75 to 1.5, preferably 0.8 to 1.2.

5. A method according to claim 1 wherein the volume median diameter of the water droplets at 1 m from the nozzle opening is in the range 0.5 to 1.5 mm.

6. A method according to claim 1 wherein the average water droplet velocity at the centre of the spray at 1 m from the nozzle opening is not more than 35 m/s, preferably not more than 30 m/s

7. A method according to claim 1 wherein the average water droplet velocity at the centre of the spray at 1 m from the nozzle opening is not less than 15 m/s, preferably not less than 20 m/s.

8. A method according to claim 1 wherein the water flow rate is in the range 14 to 28 l/min.

9. A method according to claim 1 wherein the volumetric ratio of the gas flow to the water stream is at least 100, preferably at least 200.

10. A method according to claim 1 wherein the volumetric ratio of the gas flow to the water stream is not more than 600.

11. A method according to claim 1 wherein the gas flow is an air flow.

12. A method of cleaning a hard surface comprising directing at the surface a water spray generated by a method according to claim 1.

13. Apparatus for generating a water spray, having a water spray nozzle with an opening for the ejection of a water stream, means for providing a flow of pressurised water to the nozzle opening, a gas flow tube surrounding the nozzle opening and extending downstream thereof to an open end, and means for providing a gas flow along the gas flow tube alongside the water stream ejected from the nozzle opening, wherein the ratio of the cross sectional areas of said opening of the nozzle and of the gas flow tube at the location of the nozzle is in the range 1/50 to 1/600, preferably 1/100 to 1/400.

14. Apparatus according to claim 13 adapted and arranged to provide a flow rate of water of at least 14 l/min.

15. Apparatus according to claim 13 wherein the minimum internal cross-section dimension of the gas flow tube at the nozzle opening and downstream thereof is at least 30 mm, preferably at least 40 mm.

16. Apparatus according to claim 13 wherein length of the gas flow tube downstream of the nozzle opening is in the range 1 to 3 times the average cross-sectional dimension of the gas flow tube at the location of the nozzle opening.

17. Apparatus according to claim 13 wherein the gas flow is an air flow.
